(19) United States
(12) Patent Application Publication
(10) Pub. No.: US 2026/0027573 A1
(43) Pub. Date: Jan. 29, 2026

(54) Dual-Purpose Spray Gun Apparatus

(71) Applicant: Bosen ZHANG, Zhejiang (CN)

(72) Inventor: Bosen ZHANG, Zhejiang (CN)

(21) Appl. No.: 19/009,746

(22) Filed: Jan. 3, 2025

(30) Foreign Application Priority Data
Jul. 25, 2024 (CN) 202421787523.0

(51) Int. Cl. B05B 7/24

(52) U.S. Cl. CPC B05B 7/2408; B05B 7/2416; B05B 7/2472

(57) ABSTRACT

The present disclosure provides a dual-purpose spray gun apparatus, including a base and a hand-held gun body detachably connected to the base. The hand-held gun body is provided with a pot cover, and the pot cover is detachably connected to a first material pot; the base is provided with an insertion port allowing the hand-held gun body to be inserted into the base; the base is further provided with a detachable second material pot, and the second material pot is provided with a spout; and when the hand-held gun body is inserted into the base, the pot cover is separated from the first material pot and connected to the spout of the second material pot.

### CROSS-REFERENCE TO RELATED APPLICATIONS

The present application claims priority to the Chinese Patent Application No. 202421787523.0, filed on Jul. 25, 2024 and entitled “DUAL-PURPOSE SPRAY GUN APPARATUS”, which is incorporated herein by reference in its entirety and amendments thereof.

### TECHNICAL FIELD

The present disclosure relates to the technical field of spray guns, in particular to a dual-purpose spray gun apparatus.

### BACKGROUND

The working principle of a paint spray gun is to use compressed air as the source power, the compressed air passes through the inside of the spray gun and then is sprayed out from an air cap, and an extremely strong negative pressure is generated at the front end of a nozzle to suck paint out of the nozzle. Under the action of high-speed jet force of the compressed air, the paint is atomized into small droplets to be evenly sprayed on the surface of a workpiece.

The volume of an existing hand-held spray gun is small, and the volume of a material pot thereof is generally small, so the spray gun is only suitable for small-area spraying. When large-area spraying is needed, the material pot needs to be removed several times for liquid filling, and the operation is frequent. However, in order to increase the volume of the material pot, some spray guns are set to be in a drag type, rollers are mounted at a base of the spray gun, and then a gun head assembly of the spray gun is connected to a gun body through a hose. However, the drag type spray gun with the large volume is not convenient enough to carry, and when only small-area spraying is needed, a waste of resources is caused.

Therefore, it is necessary to propose a novel spray gun apparatus to solve the above mentioned problems.

### SUMMARY

The present disclosure provides a dual-purpose spray gun apparatus to solve the problems mentioned in the above background.

In order to achieve the above objective of the present disclosure, the present disclosure provides a dual-purpose spray gun apparatus, including a base and a hand-held gun body detachably connected to the base. The hand-held gun body is provided with a discharge end and a pot cover, and the pot cover is detachably connected to a first material pot. The base is provided with an insertion port allowing the hand-held gun body to be inserted into the base. The base is further provided with a detachable second material pot, and the second material pot is provided with a spout. When the hand-held gun body is inserted into the base, the pot cover is separated from the first material pot and connected to the spout of the second material pot.

The discharge end of the hand-held gun body is detachably connected to a gun head assembly or a nozzle.

The present disclosure further provides a dual-purpose spray gun apparatus, including a base and a hand-held gun body detachably connected to the base. The hand-held gun body is provided with a trigger and a pot cover, and the pot cover is detachably connected to a first material pot. The base is provided with an insertion port allowing the hand-held gun body to be inserted into the base. The base is further provided with a detachable second material pot, and the second material pot is provided with a spout. When the hand-held gun body is inserted into the base, the pot cover is separated from the first material pot and connected to the spout of the second material pot. The base is provided with a toggle mechanism configured to pull the trigger, and the hand-held gun body maintains a starting state through the toggle mechanism.

The present disclosure further provides a dual-purpose spray gun apparatus, including a base and a hand-held gun body detachably connected to the base. The hand-held gun body is provided with a pot cover, and the pot cover is detachably connected to a first material pot. The base is provided with an insertion port allowing the hand-held gun body to be inserted into the base. The base is further provided with a detachable second material pot, and the second material pot is provided with a spout. When the hand-held gun body is inserted into the base, the pot cover is separated from the first material pot and connected to the spout of the second material pot.

### BRIEF DESCRIPTION OF DRAWINGS

The specification accompanying drawings which constitute a part of the present application are intended to provide a further understanding of the present disclosure. The illustrative embodiments of the present disclosure and the description thereof are intended to be illustrative of the present disclosure and do not constitute an improper limitation of the present disclosure. In the accompanying drawings:

FIG. 1 is a schematic structural diagram of the present disclosure used as a drag type spray gun.

FIG. 2 is a schematic diagram of a state when a toggle mechanism does not lock a trigger of a hand-held spray gun according to the present disclosure.

FIG. 3 is a schematic diagram of a state when a toggle mechanism locks a trigger of a hand-held spray gun according to the present disclosure.

FIG. 4 is a decomposition schematic diagram of a toggle mechanism according to the present disclosure.

FIG. 5 is a schematic structural diagram of a toggle mechanism according to the present disclosure.

FIG. 6 is a part sectional view of the present disclosure.

FIG. 7 is a partial enlarged schematic diagram of part A in FIG. 6.

FIG. 8 is a decomposition schematic diagram of the present disclosure.

FIG. 9 is a decomposition schematic diagram of the present disclosure from another perspective.

FIG. 10 is a partial enlarged schematic diagram of part B in FIG. 9.

FIG. 11 is a schematic structural diagram of a hand-held spray gun according to the present disclosure.

FIG. 12 is a partial enlarged schematic diagram of part C in FIG. 11.

FIG. 13 is a schematic structural diagram of the present disclosure used as a hand-held spray gun.

### REFERENCE NUMERALS

Base (1); Inner cavity (11); Elastic positioning piece (12); Mounting seat (13); Locking sleeve (14); First locking groove (15); Radial groove (151); Axial groove (152); First power supply slot (16); Insertion port (17); Hand-held gun body (2); First material pot (21); Nozzle (22); Pot cover (23); Trigger (24); Second locking groove (25); Grip handle (26); Second power supply slot (261); Discharge end (27); Gun head assembly (3); Second material pot (4); Spout (41); Charging port (42); Charging cover (43); Positioning bump (44); Hose (5); Battery pack (6); Toggle mechanism (7); Rotary knob (71); Shifting lever (72); Spring (73); Eccentric block (74); Locking pin (75); latch (8); and Roller (9).

### DESCRIPTION OF EMBODIMENTS

The technical solutions in the embodiments of the present disclosure will be clearly and completely described below with reference to the accompanying drawings in the embodiments of the present disclosure. Apparently, the described embodiments are a part of the embodiments of the present disclosure, rather than all the embodiments. The following description of at least one exemplary embodiment is in fact illustrative and in no way constitutes any limitation on the present disclosure and application or use thereof. All other embodiments derived by a person of ordinary skill in the art from the embodiments in the present disclosure without any creative effort fall within the scope of protection of the present disclosure.

It is to be noted that the terms used here are intended only to describe the specific implementations and are not intended to limit exemplary implementations according to the present application. As used here, the singular form is also intended to include the plural form unless the context expressly indicates otherwise, and in addition, it should also be understood that when the terms “contain” and/or “include” are used in this specification, they indicate the presence of features, steps, operations, devices, components, and/or combinations thereof.

Unless otherwise specified, the relative arrangement, numerical expressions and values of the components and steps set forth in these embodiments do not limit the scope of the present disclosure. Meanwhile, it is to be understood that the dimensions of the various parts illustrated in the accompanying drawings are not drawn to scale for ease of description. Techniques, methods and devices known to a person of ordinary skill in the related art may not be discussed in detail, but should be considered as part of the specification of the grant where appropriate. In all examples illustrated and discussed herein, any specific values should be construed as exemplary and not as limitations. Thus, other examples of the exemplary embodiments may have different values. It is to be noted that similar symbols and letters indicate similar terms in the following accompanying drawings, so that once an item is defined in one of the accompanying drawings, no further discussion thereof is required in the subsequent accompanying drawings.

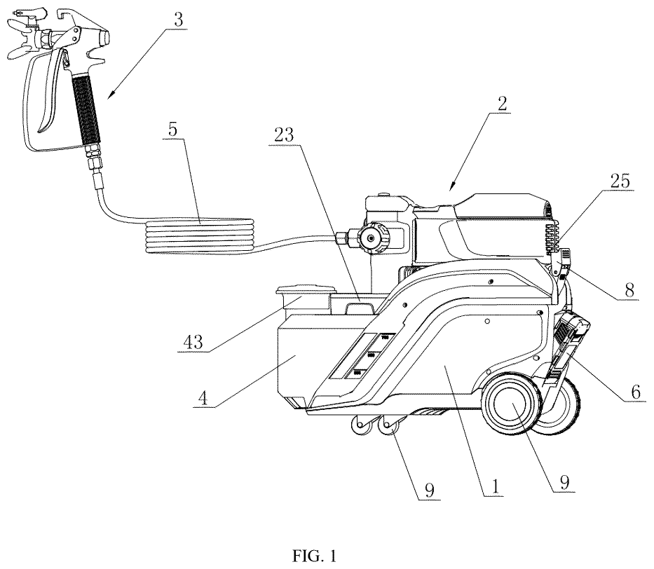

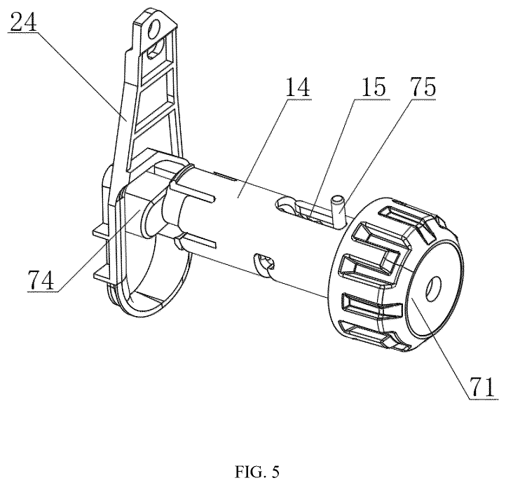

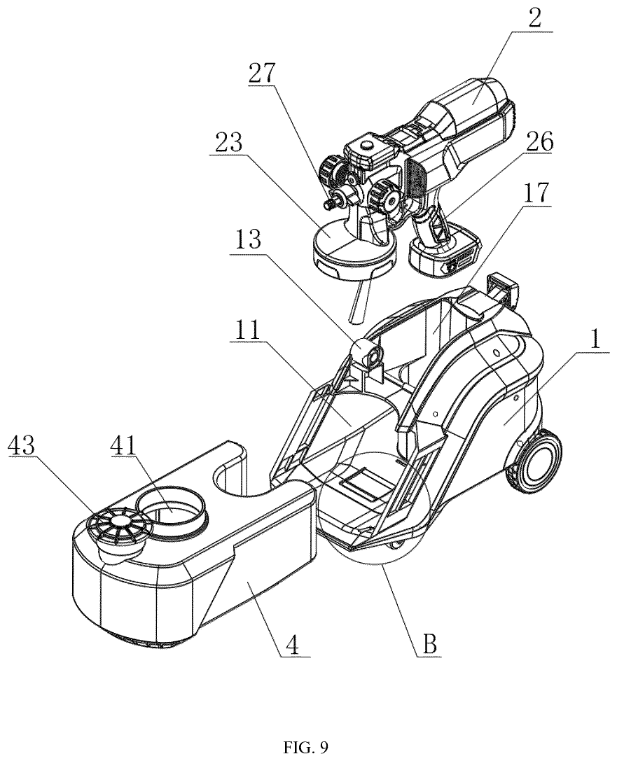

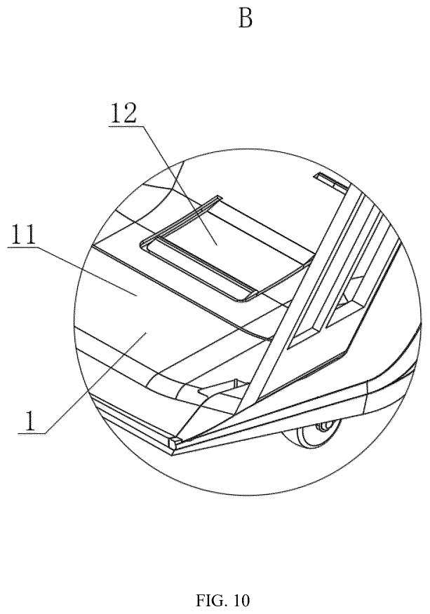

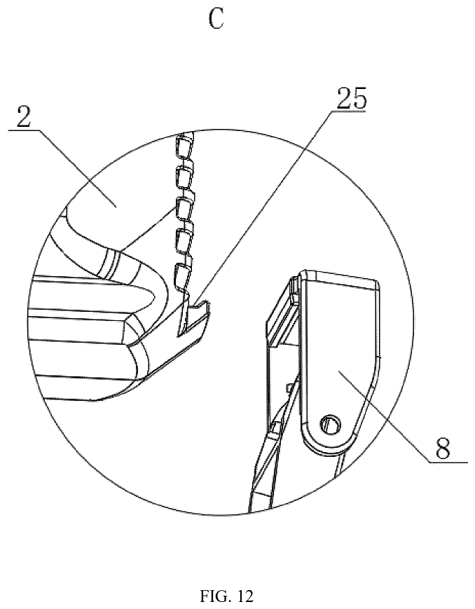

As shown in FIGS. 1 to 13, the present disclosure discloses a dual-purpose spray gun apparatus, including a base 1 and a hand-held gun body 2 detachably connected to the base 1. The hand-held gun body 2 is provided with a discharge end 27 and a pot cover 23, and the pot cover 23 is detachably connected to a first material pot 21. The base 1 is provided with an insertion port 17 allowing the hand-held gun body 2 to be inserted into the base 1. The base 1 is further provided with a detachable second material pot 4, and the second material pot 4 is provided with a spout 41. When the hand-held gun body 2 is inserted into the base 1, the pot cover 23 is separated from the first material pot 21 and connected to the spout 41 of the second material pot 4. The discharge end 27 of the hand-held gun body 2 is detachably connected to a gun head assembly 3 or a nozzle 22.

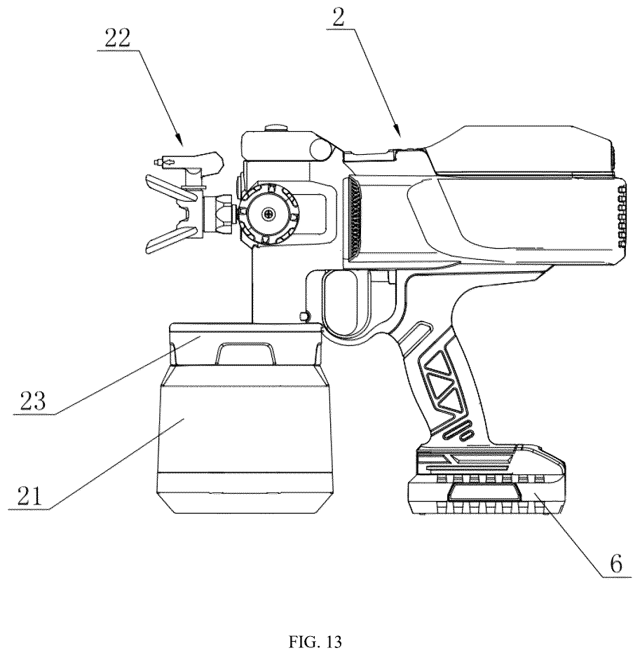

As shown in FIG. 13, in the present embodiment, the hand-held gun body 2 is an electric spray gun and is provided with a grip handle 26, the grip handle 26 can be grasped by hand, a second power supply slot 261 is formed in the grip handle 26, and a connector is disposed in the second power supply slot 261. A battery pack 6 can be inserted into the second power supply slot 261. When the battery pack 6 is inserted, the battery pack can communicate with the connector of the second power supply slot 261 so as to supply power to the hand-held gun body 2. The first material pot 21 can be filled with paint, and the pot cover 23 is provided with a suction pipe extending into the first material pot 21. Therefore, when the hand-held gun body 2 is started, the paint in the first material pot 21 can be sucked through the suction pipe and then sprayed out through the nozzle 22 at the spray end, such that the hand-held type spraying of the paint can be realized.

As shown in FIG. 1, rollers 9 are disposed at the bottom of the base 1, and the base 1 can move on the ground through the rollers 9. The volume of the second material pot 4 is greater than that of the first material pot 21, such that the second material pot 4 can be filled with more paint. The first material pot 21 and the battery pack 6 on the hand-held gun body 2 are removed, then when the hand-held gun body 2 is inserted into the base 1, the pot cover 23 can cover the spout 41 of the second material pot 4, and the suction pipe enters into the second material pot 4. Therefore, after the hand-held gun body 2 is started, the paint in the second material pot 4 can be sucked and then sprayed out through the gun head assembly 3 at the spray end, such that the drag type spraying can be realized. In the present embodiment, the gun head assembly 3 is provided with a hose 5, and the hose 5 is detachably connected to the discharge end 27. A distance between the gun head assembly 3 and the base 1 can be extended by the hose 5, thereby extending the working range and realizing remote spraying work.

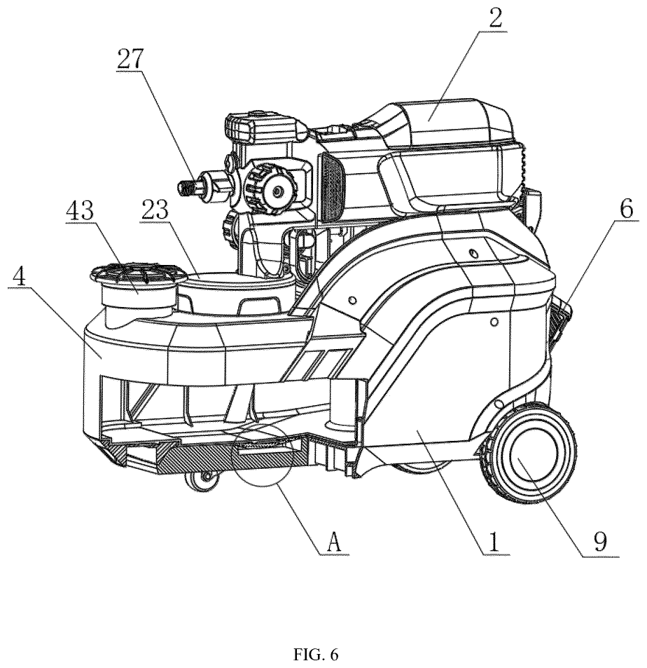

According to the above, as shown in FIGS. 6 to 10, the preferred connection mode among the hand-held gun body 2, the second material pot 4 and the base 1 is that: the base 1 is provided with an inner cavity 11, the insertion port 17 is formed in one end of the inner cavity 11, the hand-held gun body 2 is provided with the grip handle 26 for grabbing, and the grip handle 26 penetrates through the insertion port 17 and is inserted into the inner cavity 11. The second material pot 4 is connected to the inner cavity 11 in an inserted manner, and at least a part of the second material pot 4 penetrates out of the inner cavity 11. A positioning structure is disposed between the second material pot 4 and the inner cavity 11, and when the second material pot 4 is inserted into the inner cavity 11, movement of the second material pot 4 is limited by the positioning structure. The positioning structure includes an elastic positioning piece 12 and a positioning bump 44 which are separately disposed on the inner cavity 11 and the second material pot 4; and when the second material pot 4 is inserted into the inner cavity 11, the positioning bump 44 slides through the elastic positioning piece 12 and abuts against the elastic positioning piece 12.

In the present embodiment, the elastic positioning piece 12 is disposed on the bottom face of the inner cavity 11, the positioning bump 44 is disposed at the bottom of the second material pot 4, and the inner cavity 11 is provided with an opening allowing the second material pot 4 to be pulled and inserted. The grip handle 26 of the hand-held gun body 2 can be inserted into the inner cavity 11 through the insertion port 17, such that the hand-held gun body 2 can be mounted on the base 1.

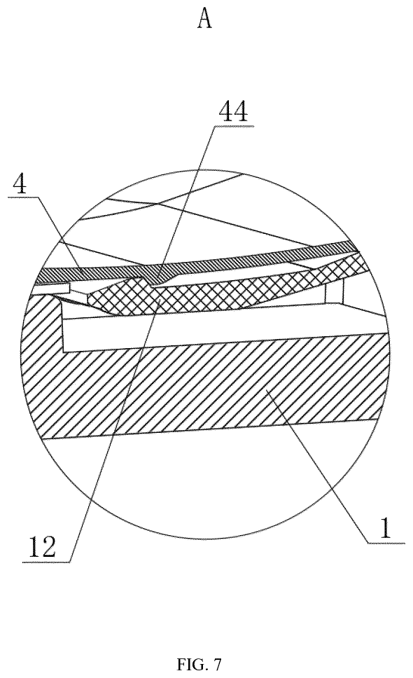

Moreover, in the present embodiment, the second material pot 4 can be pulled from the inner cavity 11, such that the second material pot 4 can be conveniently filled with the paint or cleaned. When the second material pot 4 is mounted, the second material pot 4 can be directly inserted into the inner cavity 11, and in the process of inserting the second material pot 4 into the inner cavity 11, the positioning bump 44 slides through the elastic positioning piece 12 and abuts against the elastic positioning piece 12. In this way, the elastic positioning piece 12 can match with the inner wall of the inner cavity 11 to position and pre-fix the second material pot 4 so as to avoid large displacement of the second material pot 4 on the base 1, as shown in FIG. 6 and FIG. 7.

In other embodiments of the positioning structure (not shown in the figure), the positioning structure may also perform positioning in the form of a clamping groove and a clamping block. For example, when the second material pot 4 is inserted into the innermost part of the inner cavity 11, a buckle will be clamped into the clamping groove for clamped positioning.

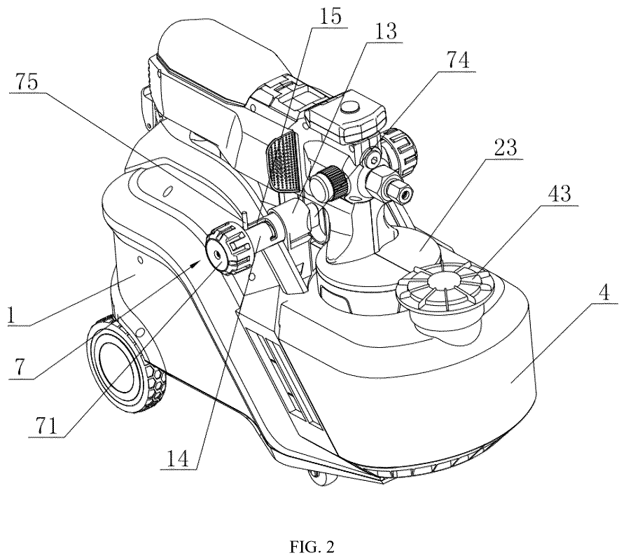

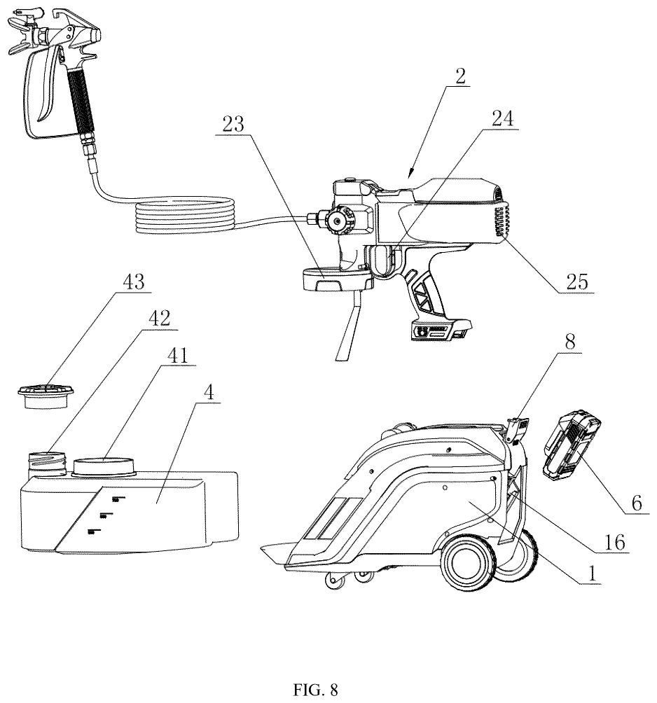

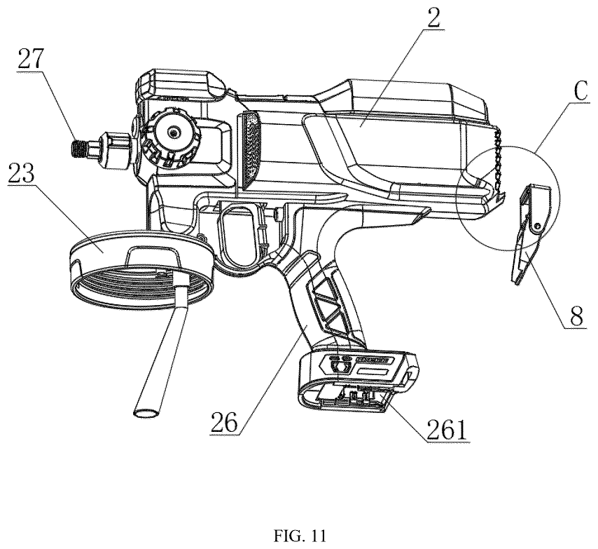

In the present embodiment, as shown in FIG. 1, FIG. 2, FIG. 8 and FIG. 11, in order to improve the stability of the connection among the second material pot 4, the hand-held gun body 2 and the base 1, further, the second material pot 4 is provided with a charging port 42 close to the spout 41, the charging port 42 is detachably connected to a charging cover 43, and the charging cover 43 is configured to seal the charging port 42 and restrict the movement of the pot cover 23. When the pot cover 23 is connected to the spout 41, the charging cover 43 presses against an upper portion of the pot cover 23 and fixes the pot cover 23. A locking mechanism is further disposed between the hand-held gun body 2 and the base 1. The locking mechanism includes a latch 8, a lower end of the latch 8 is hinged to the base 1, the hand-held gun body 2 is provided with a second locking groove 25 facing towards the latch 8, and an upper end of the latch 8 is buckled into the second locking groove 25.

In the present embodiment, through the charging port 42, in the case of not dismounting the second material pot 4, the paint can be directly added into the second material pot 4. The latch 8 and the second locking groove 25 are disposed at a rear end of the hand-held gun body 2 and the base 1.

In the present embodiment, the charging cover 43 is mounted on the charging port 42 by threaded connection, and an edge of the charging cover 43 extends above the spout 41. Therefore, after the hand-held gun body 2 is mounted on the base 1, the charging cover 43 is mounted on the charging port 42. In this way, the charging port 42 can be buckled on the upper portion of the pot cover 23 while being sealed, so as to limit the upper portion of the pot cover 23 and avoid the separation between the pot cover 23 and the spout 41. Through cooperation of the latch 8 and the second locking groove 25, the rear end between the hand-held gun body 2 and the base 1 can be fixed. In this way, connection among the second material pot 4, the hand-held gun body 2 and the base I can be fastened so as to avoid looseness.

The connection mode of the charging cover 43 and the charging port 42 is not only limited to the above threaded connection, but in other embodiments (not shown in the figure), the buckle connection, magnetic connection, and the like may also be adopted.

The limiting mode of the charging cover 43 to the pot cover 23 is also not only limited to the above press fit mode, but in other embodiments (not shown in the figure), the clamped connection mode may also be adopted for fixing. For example, the clamping block and the clamping groove are correspondingly disposed on the charging cover 43 and the pot cover 23. When the charging cover 43 is buckled on the charging port 42, the buckle will be clamped exactly with the clamping groove, so as to fix and limit the pot cover 23.

In the present disclosure, after the hand-held gun body 2 is mounted on the base 1, in order to continue to supply power to the hand-held gun body 2, the base 1 is further provided with a power supply mechanism, and when the hand-held gun body 2 is inserted into the base 1, the hand-held gun body 2 is electrically connected to the power supply mechanism. The power supply mechanism may be a power cord or the battery pack 6, etc.

In the present embodiment, the inner cavity 11 is provided with a second connector adapted to the connector in the second power supply slot 261, and the second connector is electrically connected to the power supply mechanism. Therefore, after the grip handle 26 is inserted into the inner cavity 11, the connector in the second power supply slot 261 will make contact and communicate with the second connector, and then the power supply mechanism can supply power to the hand-held gun body 2.

According to the above, when the power supply mechanism is the power cord, the power cord can be directly connected with an external power supply, so as to supply power to the hand-held gun body 2 through the external power supply.

When the power supply mechanism is the battery pack 6, as shown in FIG. 8, a first power supply slot 16 configured to mount the battery pack 6 is correspondingly formed in the base 1, a third connector is disposed in the first power supply slot 16, and the third connector is electrically connected to the second connector of the inner cavity 11. Therefore, when the battery pack 6 is inserted into the first power supply slot 16, the battery pack 6 is connected to the third connector, then the third connector transfers the power in the battery pack 6 to the second connector, and then the second connector transfers the power to the hand-held gun body 2, and supplies the power to the hand-held gun body 2. Therefore, in this way, mobile power supply can be realized.

When a drag type spraying function of the present disclosure is used, in order to ensure continuous operation and working of the hand-held gun body 2, the base 1 is provided with a toggle mechanism 7 configured to pull a trigger 24, and the hand-held gun body 2 maintains a starting state through the toggle mechanism 7, as shown in FIGS. 2 to 5.

In a preferred embodiment of the toggle mechanism 7, the base 1 is provided with a mounting seat 13, the mounting seat 13 is fixedly provided with a locking sleeve 14, the locking sleeve 14 is provided with a first locking groove 15, and the first locking groove 15 is composed of an axial groove 152 and a radial groove 151 communicating with each other. The toggle mechanism 7 includes a shifting lever 72 capable of rotating and sliding, one end of the shifting lever 72 penetrates through the locking sleeve 14 and the mounting seat 13 and is provided with an eccentric block 74, and the eccentric block 74 can extend into an inner side of the trigger 24. The shifting lever 72 is provided with a locking pin 75, and the locking pin 75 penetrates through the first locking groove 15 and can slide between the axial groove 152 and the radial groove 151. When the locking pin 75 slides into the radial groove 151, the eccentric block 74 turns over and pulls the trigger 24, and the hand-held gun body 2 maintains the starting state.

In the present embodiment, the shifting lever 72 is capable of rotating and sliding in the locking sleeve 14, and the locking pin 75 and the eccentric block 74 slide or rotate simultaneously when the shifting lever 72 rotates and slides. Moreover, the shifting lever 72 is sleeved with a spring 73, and when the shifting lever 72 slides, the spring 73 will be compressed and produce elasticity, such that the locking pin 75 is fixed in the required position through the elasticity of the spring 73. A rotary knob 71 is disposed at one end of the shifting lever 72 facing away from the hand-held gun body 2. The shifting lever 72 can be twisted to rotate by manipulating the rotary knob 71 so as to push the shifting lever 72 to slide. The eccentric block 74 is provided with a protrusion portion deviating from the axis of the shifting lever 72.

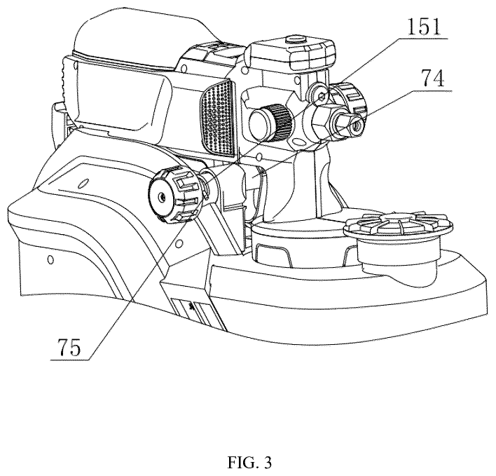

The axial groove 152 is disposed perpendicular to the hand-held gun body 2, the radial groove 151 is disposed parallel with the hand-held gun body 2, and the radial groove 151 is disposed at one end of the axial groove 152 close to the hand-held gun body 2. Therefore, when the shifting lever 72 is pushed to slide towards the hand-held gun body 2, the locking pin 75 will slide to one end of the axial groove 152 close to the hand-held gun body 2. Then, the shifting lever 72 is twisted to radially rotate, and the locking pin 75 will slide into the radial groove 151. When the shifting lever radially rotates, the eccentric block 74 also rotates synchronously. Therefore, the rotating eccentric block 74 can push the trigger 24 to rotate by using the eccentric protrusion portion of the eccentric block, so as to pull the trigger 24 and start the hand-held gun body 2. After the hand-held gun body 2 is started, the shifting lever 72 is released, and the spring 73 uses the rebound force to clamp the locking pin 75 in the radial groove 151, such that the eccentric block 74 is always in a state of pulling the trigger 24, and the hand-held gun body 2 is always allowed to work continuously, as shown in FIG. 3.

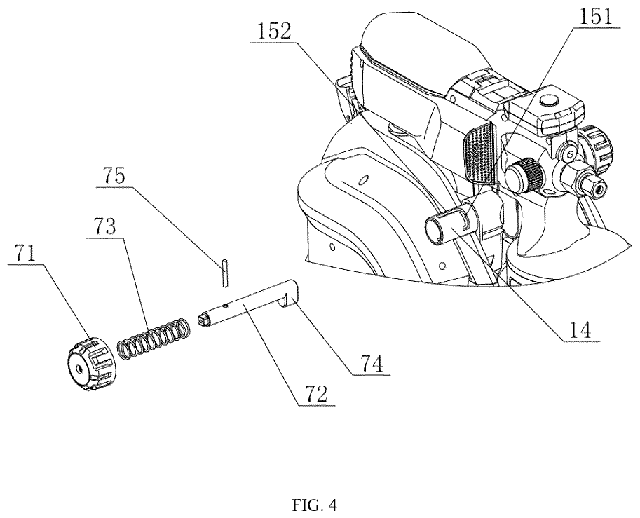

In order to improve the stability of the locking pin 75 staying in the radial groove 151, a concave portion may also be formed in the radial groove 151, as shown in FIG. 4. After the hand-held gun body 2 is started, the locking pin 75 can be clamped into the concave portion, such that the locking pin 75 is not likely to loosen, and the continuous working stability of the hand-held gun body 2 is improved, as shown in FIG. 3.

If the hand-held gun body 2 needs to be closed, just the locking pin 75 slides back into the axial groove 152, and the eccentric block 74 will be out of contact with the trigger 24, such that the trigger 24 is reset and the hand-held gun body 2 is closed.

In summary, an application method of the present disclosure is as follows: when only small-area spraying is needed, the hand-held gun body 2 can be directly handheld for spraying. When the hand-held gun body 2 needs to be mounted into the base 1 to use as a drag type spray gun, the first material pot 21 and an assembly of the nozzle 22 on the hand-held gun body 2 are first removed, the hand-held gun body 2 is put into the inner cavity 11 of the base 1, then the pot cover 23 on the hand-held gun body 2 is matched with the spout 41 of the second material pot 4, the charging cover 43 is tightened on the charging port 42 and presses the pot cover 23, and then the latch 8 on the base 1 is buckled with the second locking groove 25 at the rear end of the hand-held gun body 2, such that the hand-held gun body 2 is locked on the base 1. At the same time, the power end of the hand-held gun body 2 is in insertion fit with one end of a power adapter, the battery pack 6 is inserted into the first power supply slot 16, and the battery pack 6 is in insertion fit with the other end of the power adapter, such that the hand-held gun body 2 is powered on. Then, the gun head assembly 3 is connected to the front end of the hand-held gun body 2 through the hose 5, then the shifting lever 72 is pushed inward and the locking pin 75 is screwed into the axial groove 152 of the first locking groove 15, the shifting lever 72 drives the eccentric block 74 to rotate, the eccentric block 74 pushes and locks the trigger 24 on the hand-held gun body 2, such that the hand-held gun body 2 is in a working state, and then the gun head assembly 3 is started for spraying operation. When the spraying is finished, the rotary knob 71 is rotated, such that the locking pin 75 slides out of the axial groove 152 of the first locking groove 15 and enters into the radial groove 151, the spring 73 pushes the shifting lever 72 to outward move to reset, the eccentric block 74 unlocks the trigger 24 on the hand-held gun body 2, the trigger 24 is reset, and the hand-held gun body 2 stops working.

From the above description, it may be seen that the present disclosure achieves the following technical effects.

The spray gun apparatus of the present disclosure can be used in a hand-held or drag mode, such that a user can choose the required use mode according to the actual needs. Thus, the applicability of the spray gun apparatus is improved, and the spray gun apparatus is easy to use in different work scenes.

By providing the toggle mechanism 7, the hand-held gun body 2 can be kept in continuous operation when the spray gun apparatus is used in the drag mode, without manually pressing the trigger 24 all the time for operation.

In the description of the present disclosure, it is to be understood that the directional terms “front”, “back”, “upper”, “lower”, “left”, “right”, “transverse”, “vertical”, “perpendicular”, “horizontal”, “top”, “bottom”, and so on indicate directional or positional relationships generally based on the directional or positional relationships shown in the accompanying drawings, merely to facilitate the description of the present disclosure and to simplify the description, and do not indicate or imply that the referred apparatuses or elements must have a particular orientation or be constructed and operated in a particular orientation in the absence of a statement to the contrary, and thus are not to be construed as limiting the scope of protection of the present disclosure. The directional terms “inside” and “outside” refer to the inside and outside relative to the contour of each component itself.

For ease of description, spatially relative terms such as “on”, “above”, “upper surface”, and “upper” may be used herein to describe the spatial position relationship between one device or feature and other devices or features as illustrated in the drawings. It is to be understood that the spatially relative terms are intended to encompass different orientations in use or operation in addition to the orientation of the device depicted in the drawings. For example, if the device in the accompanying drawings is inverted, a device described as “above” or “on” other devices or constructions may then be defined “below” or “under” the other devices or constructions. Thus, the exemplary term “above” may include two orientations of “above” and “below”. The device may also be positioned in other different ways (rotated by 90 degrees or in other orientations), and the spatially relative descriptions used herein are interpreted accordingly.

In addition, it is to be noted that the use of the words “first”, “second” and the like to define components is for the convenience of distinguishing the corresponding components. If not otherwise stated, the above words do not have a special meaning, and thus should not be construed to limit the scope of protection of the present disclosure.

The foregoing descriptions are only preferred embodiments of the present disclosure and are not used to limit the present disclosure. For those skilled in the art, the present disclosure may have various modifications and changes. Any modification, equivalent replacement, improvement, etc. made within the spirit and principle of the present disclosure should fall within the scope of protection of the present disclosure.

What is claimed is:

1. A dual-purpose spray gun apparatus, comprising a base and a hand-held gun body detachably connected to the base, wherein
the hand-held gun body is provided with a discharge end and a pot cover, and the pot cover is detachably connected to a first material pot;
the base is provided with an insertion port allowing the hand-held gun body to be inserted into the base;
the base is further provided with a detachable second material pot, and the second material pot is provided with a spout;
when the hand-held gun body is inserted into the base, the pot cover is separated from the first material pot and connected to the spout of the second material pot; and
the discharge end of the hand-held gun body is detachably connected to a gun head assembly or a nozzle.

2. The dual-purpose spray gun apparatus according to claim 1, wherein the base is provided with an inner cavity, the insertion port is formed in one end of the inner cavity, the hand-held gun body is provided with a grip handle for grabbing, and the grip handle penetrates through the insertion port and is inserted into the inner cavity.

3. The dual-purpose spray gun apparatus according to claim 2, wherein the second material pot is connected to the inner cavity in an inserted manner, and at least part of the second material pot penetrates out of the inner cavity.

4. The dual-purpose spray gun apparatus according to claim 3, wherein a positioning structure is disposed between the second material pot and the inner cavity, and when the second material pot is inserted into the inner cavity, movement of the second material pot is limited by the positioning structure.

5. The dual-purpose spray gun apparatus according to claim 4, wherein the positioning structure comprises an elastic positioning piece and a positioning bump which are separately disposed on the inner cavity and the second material pot; and
when the second material pot is inserted into the inner cavity, the positioning bump slides through the elastic positioning piece and abuts against the elastic positioning piece.

6. The dual-purpose spray gun apparatus according to claim 1, wherein the second material pot is further provided with a charging port close to the spout, the charging port is detachably connected to a charging cover, and the charging cover is configured to seal the charging port and restrict movement of the pot cover.

7. The dual-purpose spray gun apparatus according to claim 6, wherein when the pot cover is connected to the spout, the charging cover presses against an upper portion of the pot cover and fixes the pot cover.

8. The dual-purpose spray gun apparatus according to claim 1, wherein a locking mechanism is further disposed between the hand-held gun body and the base.

9. The dual-purpose spray gun apparatus according to claim 8, wherein the locking mechanism comprises a latch, a lower end of the latch is hinged to the base, the hand-held gun body is provided with a second locking groove facing towards the latch, and an upper end of the latch is buckled into the second locking groove.

10. The dual-purpose spray gun apparatus according to claim 1, wherein the base is further provided with a power supply mechanism, and when the hand-held gun body is inserted into the base, the hand-held gun body is electrically connected to the power supply mechanism.

11. The dual-purpose spray gun apparatus according to claim 10, wherein the power supply mechanism is a power cord, and the power cord is connected to an external power supply.

12. The dual-purpose spray gun apparatus according to claim 10, wherein the base is provided with a first power supply slot, the power supply mechanism is a battery pack, and the battery pack is inserted into the first power supply slot.

13. The dual-purpose spray gun apparatus according to claim 1, wherein the gun head assembly is provided with a hose, and the hose is detachably connected to the discharge end.

14. The dual-purpose spray gun apparatus according to claim 1, wherein the base is provided with rollers for moving.

15. A dual-purpose spray gun apparatus, comprising a base and a hand-held gun body detachably connected to the base, wherein
the hand-held gun body is provided with a trigger and a pot cover, and the pot cover is detachably connected to a first material pot;
the base is provided with an insertion port allowing the hand-held gun body to be inserted into the base;
the base is further provided with a detachable second material pot, and the second material pot is provided with a spout;
when the hand-held gun body is inserted into the base, the pot cover is separated from the first material pot and connected to the spout of the second material pot; and
the base is provided with a toggle mechanism configured to pull the trigger, and the hand-held gun body maintains a starting state through the toggle mechanism.

16. The dual-purpose spray gun apparatus according to claim 15, wherein the base is provided with a mounting seat, the mounting seat is fixedly provided with a locking sleeve, the locking sleeve is provided with a first locking groove, and the first locking groove is composed of an axial groove and a radial groove communicating with each other.

17. The dual-purpose spray gun apparatus according to claim 16, wherein the toggle mechanism comprises a shifting lever capable of rotating and sliding, one end of the shifting lever penetrates through the locking sleeve and the mounting seat and is provided with an eccentric block, and the eccentric block is able to extend into an inner side of the trigger.

18. The dual-purpose spray gun apparatus according to claim 17, wherein the shifting lever is provided with a locking pin, and the locking pin penetrates through the first locking groove and is able to slide between the axial groove and the radial groove.

19. The dual-purpose spray gun apparatus according to claim 18, wherein when the locking pin slides into the radial groove, the eccentric block turns over and pulls the trigger, and the hand-held gun body maintains the starting state.

20. A dual-purpose spray gun apparatus, comprising a base and a hand-held gun body detachably connected to the base, wherein
the hand-held gun body is provided with a pot cover, and the pot cover is detachably connected to a first material pot;
the base is provided with an insertion port allowing the hand-held gun body to be inserted into the base;
the base is further provided with a detachable second material pot, and the second material pot is provided with a spout; and
when the hand-held gun body is inserted into the base, the pot cover is separated from the first material pot and connected to the spout of the second material pot.
